(19) United States
(12) Patent Application Publication
(10) Pub. No.: US 2026/0129673 A1
(43) Pub. Date: May 7, 2026

(54) Irregular UnavailabilitySignaling

(71) Applicant: Cisco Technology, Inc., San Jose, CA (US)

(72) Inventors: Brian D. Hart, Sunnyvale, CA (US); Malcolm M. Smith, Richardson, TX (US); Binita Gupta, San Diego, CA (US)

(73) Assignee: Cisco Technology, Inc., San Jose, CA (US)

(21) Appl. No.: 19/383,030

(22) Filed: Nov. 7, 2025

Related U.S. Application Data
(60) Provisional application No. 63/717,328, filed on Nov. 7, 2024.

(51) Int. Cl. H04W 74/04; H04W 74/08; H04W 74/0816

(52) U.S. Cl. CPC H04W 74/04; H04W 74/0816; H04W 74/0875

(57) ABSTRACT

Irregular unavailability signaling may be provided. An Access Point (AP) may receive an irregular unavailability report from a station. The irregular unavailability report may include a priority associated with upcoming unavailability periods of the station for non-Peer-to-Peer (P2P) traffic and an indication of interruptibility of the P2P traffic in the upcoming unavailability periods. The AP may schedule Transmit Opportunities (TxOPs) of the non-P2P traffic to the station in the upcoming unavailability periods based on the priority associated with upcoming unavailability periods and the indication of interruptibility of the P2P traffic.

### RELATED APPLICATION

Under provisions of 35 U.S.C. § 119(e), Applicant claims the benefit of U.S. Provisional Application No. 63/717,328, filed Nov. 7, 2024, which is incorporated herein by reference.

### TECHNICAL FIELD

The present disclosure relates generally to irregular unavailability signaling.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for irregular unavailability signaling;

FIG. 2 is a flow chart of a method for providing irregular unavailability signaling; and

FIG. 3 is a block diagram of a computing device.

### DETAILED DESCRIPTION

### Overview

Irregular unavailability signaling may be provided. An Access Point (AP) may receive an irregular unavailability report from a station. The irregular unavailability report may include a priority associated with upcoming unavailability periods of the station for non-Peer-to-Peer (P2P) traffic and an indication of interruptibility of the P2P traffic in the upcoming unavailability periods. The AP may schedule Transmit Opportunities (TxOPs) of the non-P2P traffic to the station in the upcoming unavailability periods based on the priority associated with upcoming unavailability periods and the indication of interruptibility of the P2P traffic.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Streaming traffic is among the largest and fastest growing traffic on the internet. Peer-to-Peer (P2P) streaming contributes substantially to this growth. P2P traffic is a decentralized network architecture that allows Stations (STAs) to interact directly with each other. An example of P2P traffic in Ultra High Reliability (UHR) may relate to In-Device Coexistence (IDC) such as a phone with Wireless Fidelity (WiFi) unlocking a car using Ultra Wide Band (UWB) signal or streaming audio to a car stereo using Bluetooth. If unlocking a car or its Bluetooth audio stream is more important to a user than a WiFi traffic at that time, then the phone may not transmit if the WiFi traffic may disrupt the P2P traffic or non-Wi-Fi traffic. Herein “P2P” may encompass all wireless communications and emissions not related to the traditional WiFi use case of communications between a STA and an Access Point (AP) towards providing access the intranet/Internet. P2P may include cellular communication, in-channel emissions, Radio Frequency (RF) images and/or spurs, etc. at other frequencies.

If a STA does not send an indication in a frame such as a Quality of Service (QoS) Null packet with Power Management (PM) bit value 1 to an AP indicating STA's unavailability for the non-P2P traffic or the WiFi traffic, or some other technique such as CTS-To-Self, then the AP may continue to send a Downlink (DL) traffic to the STA. The AP however may not receive an Acknowledgment (Ack) or a Block Ack (BA) for the DL traffic as the STA may be busy transmitting/receiving the P2P traffic and may not be available for the non-P2P traffic. When the AP does not receive any Ack/BA for the DL traffic, the AP may retry sending the DL traffic with a repeatedly lowered Modulation Coding Scheme (MCS). Repeated retries may result in wasted wireless medium time. The disclosure provides processes for a STA to send an irregular unavailability report to an AP of upcoming irregular absences. Based on the upcoming irregular unavailability, the AP may schedule the DL traffic to avoid wasted wireless medium time. The disclosed processes may also be implemented by an AP to send an irregular unavailability report to a STA of upcoming irregular unavailability.

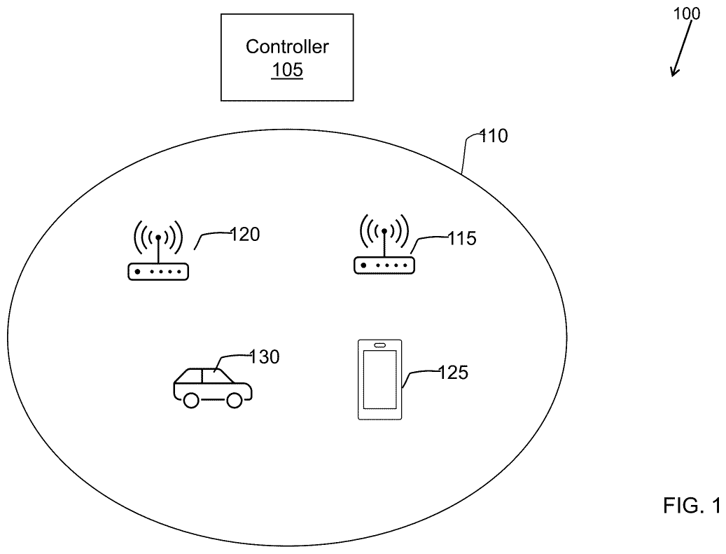

FIG. 1 shows an operating environment 100 for authorization for irregular unavailability signaling. As shown in FIG. 1, operating environment 100 may comprise a controller 105 and a coverage environment 110. Coverage environment 110 may comprise, but is not limited to, a Wireless Local Area Network (WLAN) comprising a plurality of APs that may provide wireless network access (e.g., access to the WLAN for client devices). The plurality of APs may comprise a first AP 115 and a second AP 120. The plurality of APs may provide wireless network access to a plurality of STAs as they move within coverage environment 110. The plurality of STAs may comprise, but are not limited to, a first STA 125 and a second STA 130. One or more of the STAs may have multiple radios, beyond a radio for Internet/intranet connectivity (for example, Wi-Fi for P2P, cellular, BT, UWB, etc). Ones of the plurality of STAs may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, AR/VR/XR devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of STAs may use Multi-Link Operation (MLO) where they simultaneously transmit and receive across different bands and channels by establishing two or more links to two or more AP radios. These bands may comprise, but are not limited the 2.4 GHz band, the 5 GHz band, the 6 GHz band, and the 60 GHz band.

Controller 105 may comprise a Wireless Local Area Network (LAN) Controller (WLC) and may provision and control coverage environment 110 (e.g., a Wireless LAN (WLAN)). Controller 105 may allow first STA 125 and second STA 130 to join coverage environment 110. In some implementations of the disclosure, controller 105 may be implemented by a Digital Network Architecture Center (DNAC) controller (i.e., a Software-Defined Network (SDN) controller) that may configure information for coverage environment 110 in order to provide irregular unavailability signaling.

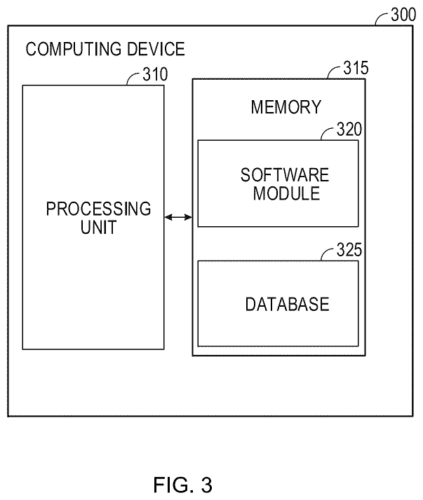

The elements described above of operating environment 100 (e.g., controller 105, first AP 115, second AP 120, first STA 125, and second STA 130) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

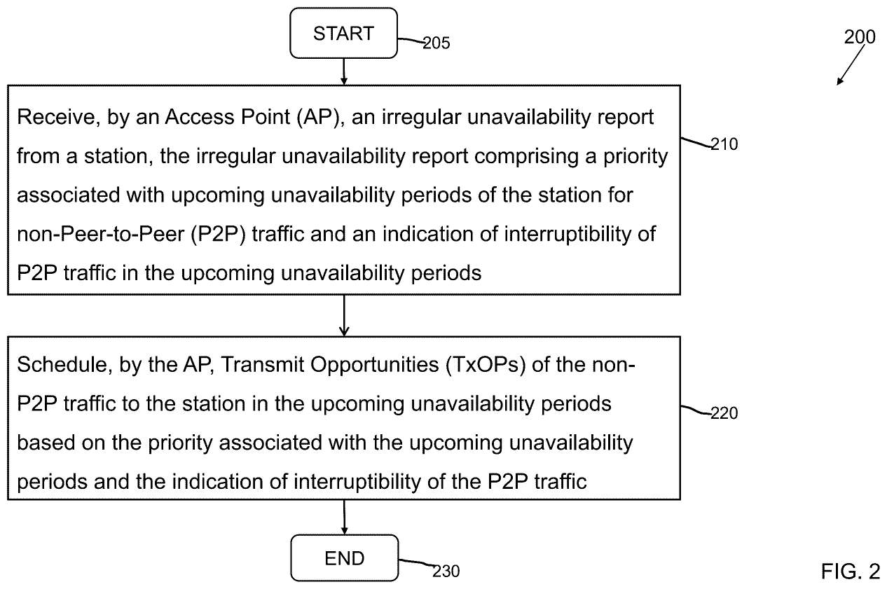

FIG. 2 is a flow chart setting forth the general stages involved in a method 200 consistent with implementations of the disclosure for irregular unavailability signaling. Method 200 may be implemented using first AP 115 and first STA 125 as described in more detail above with respect to FIG. 1. Ways to implement the stages of method 200 will be described in greater detail below.

Method 200 may begin at starting block 205 and proceed to stage 210 where first AP 115 may receive an irregular unavailability report from first STA 125. The irregular unavailability report may include a priority associated with upcoming unavailability periods of first STA 125 for P2P traffic and an indication of an interruptibility (also referred to as an interruptible indication) of the P2P traffic in the upcoming unavailability periods.

The priority associated with the upcoming unavailability periods of first STA 125 for the P2P traffic may be indicated in one or more of Access Category (AC), User Priority (UP), and Traffic Identifier (TID), or Stream Classification Service ID (SCSID) fields. The priority associated with the upcoming unavailability periods of first STA 125 for the P2P traffic may be indicated using 2-4 bits. In some examples, the priority associated with upcoming unavailability periods of first STA 125 for P2P traffic may indicate a priority needed to interrupt an unavailability of first STA 125 in the upcoming unavailability periods (that is, a priority of the non-P2P traffic or a minimum predetermined priority for the non-P2P traffic). In some examples, the priority associated with the upcoming unavailability periods of first STA 125 for P2P traffic may indicate a priority of the P2P traffic during the upcoming unavailability periods. The priority values may be mapped to a nominal expiry imminence time, for non-data services such as ranging.

The indication of interruptibility may be provided in a field or a sub-field that may be 0-3 bits long, and may be provided in one or more of AC, UP, and TID fields. Different values of the indication of interruptibility may indicate different criteria for the non-P2P traffic to be able to interrupt the P2P traffic during the upcoming unavailability periods of first STA 125. For example, a first value may indicate that interruptibility is not permitted or not allowed (that is, the P2P traffic is uninterruptible) during the upcoming unavailability periods. In one example implementation, the first value may also be indicated by an unavailability of the indication of interruptibility values. In another implementation, the first value may be indicated by the fields or sub-fields corresponding to the indication of interruptibility being reserved or not populated.

A second value of the indication of interruptibility may indicate that the P2P traffic may be interruptible when the priority of the TxOP of the non-P2P traffic is greater than the P2P traffic priority for the upcoming unavailability periods or greater than a predetermined priority, the non-P2P traffic has already started, and first STA 125 does not need to respond.

A third value of the indication of interruptibility may indicate that the P2P traffic may be interruptible when a priority of the TxOP of the non-P2P traffic is greater than the P2P traffic priority for the upcoming unavailability periods or is greater than a predetermined priority, the non-P2P traffic has already started, and first STA 125 is able to respond.

A fourth value of the indication of interruptibility may indicate that the P2P traffic may be interruptible when first STA 125 may not need to respond. For the fourth value, the P2P traffic may be interruptible for any priority of the non-P2P traffic starting at any time. The fourth value may be indicated by leaving bit values corresponding to the indication of interruptibility in the AC, UP, and TID fields reserved.

A fifth value of the indication of interruptibility may indicate that the P2P traffic may be interruptible for serving the non-P2P traffic having a higher priority than the P2P traffic at any time. A sixth value of the indication of interruptibility may indicate that the P2P traffic may be interruptible for the conditions associated with the fourth and the fifth values as discussed above. As discussed above, for a maximum compression, no bits may be allocated for the indication of interruptibility. In the unavailability of bits for the indication of interruptibility, AC/UP/TID may indicate a priority needed to interrupt the unavailability activity at (for example, the sixth value) but sending highest priority AC/UP/TID may mean the first value. Thus, the priority associated with upcoming unavailability periods of first STA 125 for the P2P traffic and the indication of interruptibility of the P2P traffic in the upcoming unavailability periods may be provided in 2-7 bits field

In one example, first STA 125 may send an irregular unavailability report comprising the priority associated with the upcoming unavailability periods and the indication of interruptibility to first AP 115 in response to detecting that first STA 125 may be subject to IDC. For example, first STA 125 may be involved in a P2P traffic with second STA 130. In some examples, IDC unavailability or irregular unavailability may only be predicted within a very short time frame (for example, 10-20 milli seconds) into the future.

In some implementations, the irregular unavailability report may be solicited, akin to a Buffer Status Report (BSR). For example, at the start of a TxOP or during a previous TxOP, first AP 115 may broadcast an irregular unavailability information request for first STA 125 or a list of STAs with triggers. First STA 125, in response to detecting the irregular unavailability information request from first AP 115, may send the irregular unavailability report to first AP 115. First AP 115 may receive the irregular unavailability report via an Uplink (UL) Physical Layer Protocol Data Unit (PPDU), such as, UL Orthogonal Frequency-Division Multiple Access (OFDMA).

In some examples, the irregular unavailability report may be sent in a control frame. The control frame may signal a list of irregular unavailability, for example, a set of timestamps where PM is changed from bit value 0 to bit value 1, from bit value 1 to bit value 0, or where first AP 115 may behave as closely as possible as if the PM bit were so changed. The control frame may include a Transmitter Address (TA) and a Receive Address (RA). The control frame may include additional fields, for example, a frame control field, a duration field, a Traffic Identifier (TID) field, a Frame Check Sequence (FCS) field, etc. The frame control field may use a new control subtype. If subtypes are getting short, a new subtype then a subtype field or category+action fields may be used, where one of these subtype field or category+action fields may indicate the irregular unavailabilitys.

The irregular unavailability report may be sent for a current link between first STA 125 and first AP 115 or for any link. For the current link between first STA 125 and first AP 115, the control frame may be 3 octets per record. 1 bit of 1 octet of the 3 octets may be used for indicating the PM (that is, bit value 1 or bit value 0), and remaining 7 bits may be reserved. Remaining 2 octets may be used for Timing Synchronization Function (TSF) indicating when the unavailability periods start/end. With 2 octets, 65 milliseconds unavailability with 1 microsecond granularity may be provided.

In another implementation, the control frame may be 16 bits per record. 1 bit of 16 bits may be used to indicate the PM (that is, bit value 1 or bit value 0). A predetermined number of bits of the remaining 15 bits may be used to indicate the TSF. The remaining bits may be kept reserved.

In a third example implementation, the control frame may be 2, 3, or 4 octets per record. Two timestamps may indicate a start of the unavailability period and an end of the unavailability period with PM not being included. Each timestamp may be 8, 12, or 16 bits long. The unavailability period may be provided with 1 or 8 microseconds granularity.

The irregular unavailability report may be sent for any link. For any link irregular unavailability report, in a first implementation, the control frame may be 3 octets per record. 4 bits of 1 octet of the 3 octets may include a link first Identifier (ID) for the link, 1 bit may indicate the PM (that is, bit value 1 or bit value 0), and remaining 3 bits may be reserved or may be used for priority signaling such a TID. Remaining 2 octets may be used for TSF indicating when the unavailability periods start/end. With 2 octets, 65 milliseconds unavailability may be reported with 1 microsecond granularity.

In a second implementation of the any link irregular unavailability report, the control frame may be 16 bits per record. 4 bits of the 16 bits may be used to indicate the link ID, 1 bit may be used to indicate the PM (that is, bit value 1 or bit value 0). The remaining 11 bits may be used to indicate the TSF.

In a third example implementation of the any link irregular unavailability report, the control frame may be 3, 4, or 5 octets per record. In such implementation, 4 bits of 1 octet may be used for the link ID and remaining 4 bits of that octet may be reserved and/or may be used for priority signaling such a TID. Remaining 2, 3, or 4 octets may be used to indicate two timestamps that may indicate a start of the unavailability period and an end of the unavailability period with the PM not being included. Each timestamp may be 8, 12, or 16 bits long. The unavailability period may be provided with 1 or 8 microseconds granularity.

In a fourth example implementation of the any link irregular unavailability report, the control frame may include a list of link records, each having: 1 octet for a link ID and a number of records for this link. Each instance of link records may be formatted as described above.

In further implementations, a timestamp using the TSF may be replaced by a 12 bits sequence number of a TID. In addition, the second timestamp may be replaced by a duration using fewer octets. Mobile Device Management (MDM) and out of band enablement may be involved for first STA 125 to disclose its P2P traffic patterns to first AP 115 or other authorized APs.

Once having received the irregular unavailability report from first STA 125 at stage 210, method 200 may proceed to stage 220 where first AP 115 schedule TxOPs of the non-P2P traffic to first STA 125 in the upcoming unavailability periods based on the priority associated with the upcoming unavailability periods and the indication of the interruptibility of the P2P traffic. In some examples, first AP 115 may parse the irregular unavailability report to determine upcoming unavailability periods of first STA 125 for non-P2P traffic. The irregular unavailability report may be parsed to determine one or more of a number of irregular unavailability, a start time of each irregular unavailability, an end time each irregular unavailability, a duration each irregular unavailability, a priority of P2P traffic causing each irregular unavailability, an interruptible indication of each irregular unavailability, etc. The irregular unavailability report may be parsed to determine the priority associated with the upcoming unavailability periods and the indication of the interruptibility of the P2P traffic.

First AP 115 may parse the irregular unavailability report, may feed the information directly to a wireless scheduler or to a module outside the scheduler that issues spoofed PM bit transitions at the indicated times. The scheduler may transmit TxOPs for non-P2P traffic for first STA 125 that may substantially or entirely avoid its unavailability periods. In this way, first AP 115 may not transmit to first STA 125 during its unavailability and thereby may avoid many retries and rate downshifting given the lack of acknowledgements from first STA 125. In some examples, first AP 115 may schedule the TxOPs for the non-P2P traffic on an alternate channel if available. Once first AP 115 schedules the TxOPs of the non-P2P traffic to first STA 125 at stage 220, method 200 may then end at stage 230.

In example implementations, the irregular unavailability report may further include an unavailability mode per unavailability period. The unavailability mode may be of 1 bit or 2 bits long. For example, a bit value 0 may indicate a first unavailability mode. The first unavailability mode for an unavailability period may indicate that first STA 125 may receive but not transmit any non-P2P traffic during the unavailability period. A bit value 1 may indicate a second unavailability mode. The second unavailability mode for an unavailability period may indicate that first STA 125 can neither receive nor transmit any non-P2P traffic during the unavailability period. A third unavailability mode for an unavailability period may indicate that first STA 125 may not or cannot receive but can transmit non-P2P traffic during the unavailability period. The third unavailability mode may be indicated using 2 bits.

Upon receipt of an unavailability mode, first AP 115 may attempt to conform to these constraints. For unavailability periods with the first unavailability mode, first AP 115 may attempt to either transmit a groupcast and/or other no acknowledgement non-P2P traffic to first STA 125. In some examples, for an unavailability period with the first unavailability mode, first AP 115 may start a DL transmission during the unavailability period such that the DL transmission ends at or after the unavailability period so that the UL BA/Ack may occur after the unavailability period. In some examples, for an unavailability period with the first unavailability mode, first AP 115 may start a DL transmission on an alternate link.

As discussed above, the irregular unavailability report may further include an indication of a priority of the unavailability traffic or the P2P traffic. In addition, the irregular unavailability report may include an interruptible indication for each unavailability period. This priority field or the interruptible indication may be a 2 bit long AC field (for example, an AC Background (AC_BK), an AC Best Effort (AC_BE), an AC Video (AC_VI), an AC Voice (AC_VO), etc.), a 3 bit field for a traffic class, a 4 bit field for a TID, a 8 bit field for Stream Classification Service (SCS) ID (or some other identifier), or two or more of these identifiers (for example, TID+SCS ID, etc.). A 1 bit interruptible indication may indicate that first STA 125 may be available for interruption by first AP 115 if first AP 115 has a higher priority traffic for first STA 125 than the P2P traffic or unavailability traffic for which first STA 125 is absent. The addition of the interruptible indication may enable first STA 125 to opt in or opt out of interruption. First STA 125 may set the interruptible indication to bit value 0 if first STA 125 is operating its Wi-Fi resources on a different channel or is performing critical transmissions, for example, 911-level flows. First STA 125 may set the interruptible indication to bit value 1 if first STA 125 is operating its Wi-Fi resources on the same channel or using different wireless resources (for example, Bluetooth, UWB, etc.).

Upon receipt, if the interruptible indication is not present or is present and is set to bit value 1, first AP 115 may interrupt or transmit to first STA 125 during an unavailability period if the non-P2P traffic at first AP 115 has a higher priority than indicated by first STA 125 for its unavailability traffic. Otherwise, first AP 115 may not interrupt first STA 125 during an unavailability period. However, first AP 115 may gather flow statistics and may consider moving first AP 115 to a channel where IDC challenges may be less likely.

In example implementations, when first STA 125 sends an irregular unavailability report frame, a frame exchange sequence may be defined where first AP 115 may send a response frame after a Short Interframe Space (SIFS) to either accept or decline one or more of the unavailability in the irregular unavailability report frame. First AP 115 may decline an unavailability if first AP 115 may already have buffered traffic for first STA 125 of a higher priority than the requested unavailability. First AP 115 may also decline an unavailability when the unavailability period may be a preferred time to deliver the non-P2P traffic and the unavailability request has no interruptible indication or the interruptible indication is set to a bit value 1.

In example implementations, a modified Request to Send (RTS) frame may be provided. The modified RTS may include a priority field. The modified RTS may include, for example, a RTS and a priority which a STA, for example, first STA 125 may send to another STA, for example, second STA 130 with IDC. The priority field in the modified RTS frame may include an indication of the priority of the traffic in a proposed TxOP. This priority field may be a 2 bits AC field (for example, an AC_BK, an AC_BE, an AC_VI, AC_VO, etc.), a 3 bits field for Traffic Class or a 4 bits field for TID, a 8 bits field for SCS ID or some other identifier, or two or more of these identifiers (e.g., TID+SCS ID, etc.). Upon receipt of the modified RTS frame, second STA 130 with IDC, knowing the priority of its other interfering traffic (that is, the source of the IDC) may choose one from the following options. First option may include canceling the interfering traffic and responding to the modified RTS frame with a modified Clear to Send (CTS) if first STA 125 traffic's priority indicates a higher priority than the priority of the interfering traffic. The second option may include continuing with the interfering traffic and not responding to the modified RTS if first STA 125 traffic's priority indicates a lower priority than the priority of the interfering traffic. A third option may include responding to the modified RTS with a modified CTS with a priority that may provide unavailability slots in the near future (using any of the implementations above) along with a priority of unavailability traffic in each of those slots.

A fourth option may include responding to the modified RTS or another frame with a modified CTS with a priority that may provide unavailability slots in the near future (using any of the implementations above) along with a priority of unavailability traffic in each of those slots.

A fifth option may include responding to the modified RTS with a modified CTS such as a control frame with subtype not equal to CTS with a priority that may provide unavailability slots in the near future (using any of the implementations above) along with a priority of unavailability traffic in each of those slots.

A sixth option may include responding to the modified RTS with a modified CTS with a priority that may provide an unavailability slot (i.e., just one instead of multiple) in the near future (using any of the implementations above) along with a priority of unavailability traffic in that slot or each of those slots.

A seventh option may include responding to the modified RTS with a modified CTS with a priority that may provide unavailability slots in the near future (using any of the implementations above including a simplified version of this that supports a single unavailability) along with a priority of unavailability traffic in each of those slots.

In accordance with example implementations, providing first STA 125 with a way to report multiple upcoming unpredictable unavailability (for example, while performing Bluetooth/UWB transmission), with a greater efficiency than sending 2N frames [i.e., frame{2n}(PM=1) and frame{2n+1}(PM=0) for the nth unavailability]. This way, first AP 115 may avoid fruitlessly trying and retrying towards first STA 125, and thereby enable first AP 115 to send useful frames to other STAs (for example, second STA 130).

FIG. 3 shows computing device 300. As shown in FIG. 3, computing device 300 may include a processing unit 310 and a memory unit 315.

Memory unit 315 may include a software module 320 and a database 325. While executing on processing unit 310, software module 320 may perform, for example, processes for authorization for a SCS request for a P2P traffic flow as described above with respect to FIG. 2. Computing device 300, for example, may provide an operating environment for controller 105, first AP 115, second AP 120, first STA 125, second STA 130, or third STA 135. Controller 105, first AP 115, second AP 120, first STA 125, second STA 130, or third STA 135 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 300 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed IS:

1. A method comprising:
receiving, by an Access Point (AP), an irregular unavailability report from a station, the irregular unavailability report comprising a priority associated with upcoming unavailability periods of the station for non-Peer-to-Peer (P2P) traffic and an indication of interruptibility of P2P traffic in the upcoming unavailability periods; and
scheduling, by the AP, Transmit Opportunities (TxOPs) of the non-P2P traffic to the station in the upcoming unavailability periods based on the priority associated with the upcoming unavailability periods and the indication of interruptibility of the P2P traffic.

2. The method of claim 1, wherein scheduling the TxOPs of the non-P2P traffic to the station in the upcoming unavailability periods comprises scheduling the TxOPs to the station to entirely avoid the upcoming unavailability periods when a priority associated the P2P traffic to the station is greater than that of the non-P2P traffic.

3. The method of claim 1, wherein scheduling the TxOPs of the non-P2P traffic to the station in the upcoming unavailability periods comprises scheduling the TxOPs of the non-P2P traffic to the station to substantially avoid the upcoming unavailability periods when the indication of the interruptibility of the P2P traffic is set to a first value.

4. The method of claim 1, wherein scheduling the TxOPs of the non-P2P traffic to the station in the upcoming unavailability periods comprises scheduling the TxOPs of the non-P2P traffic to the station during the upcoming unavailability periods in response to determining that:
the priority associated with the upcoming unavailability periods of the station is not greater than that of the non-P2P traffic;
the non-P2P traffic has already started; and
the station does not need to respond.

5. The method of claim 1, wherein scheduling the TxOPs of the non-P2P traffic to the station in the upcoming unavailability periods comprises scheduling the TxOPs of the non-P2P traffic to the station during the upcoming unavailability periods in response to determining that:
the priority associated with the upcoming unavailability periods of the station is not greater than that of the non-P2P traffic;
the non-P2P traffic has already started; and
the station is able to respond.

6. The method of claim 1, wherein scheduling the TxOPs of the non-P2P traffic to the station in the upcoming unavailability periods comprises scheduling the TxOPs of the non-P2P traffic to the station during the upcoming unavailability periods in response to determining that the station does not need to respond.

7. The method of claim 1, wherein scheduling the TxOPs of the non-P2P traffic to the station in the upcoming unavailability periods comprises scheduling the TxOPs of the non-P2P traffic to the station in the upcoming unavailability periods when a priority associated with the P2P traffic for the upcoming unavailability periods of the station is not greater than that of the non-P2P traffic.

8. The method of claim 1, further comprising:
sending a modified Request to Send (RTS) frame to the station, the modified RTS comprising a priority field comprising a priority of the non-P2P traffic.

9. A system comprising:
a memory storage; and
a processing unit disposed in a first computing device and coupled to the memory storage, wherein the processing unit is operative to:
receive an irregular unavailability report from a station, the irregular unavailability report comprising a priority associated with upcoming unavailability periods of the station for non-Peer-to-Peer (P2P) traffic and an indication of interruptibility of P2P traffic in the upcoming unavailability periods; and
schedule Transmit Opportunities (TxOPs) of the non-P2P traffic to the station in the upcoming unavailability periods based on the priority associated with the upcoming unavailability periods and the indication of the interruptibility of the P2P traffic.

10. The system of claim 9, wherein the processing unit is further operative to:
send a modified Request to Send (RTS) frame to the station, the modified RTS comprising a priority field comprising a priority of the non-P2P traffic.

11. The system of claim 10, wherein the processing unit is further operative to:
receive, from the station in response to the modified RTS frame, a modified Clear to Send (CTS) frame if a priority of the P2P traffic is higher than the priority of the non-P2P traffic.

12. The system of claim 10, wherein the processing unit is further operative to:
receive, in response to the modified RTS, a modified Clear to Send (CTS) frame comprising near future unavailability slots along with a priority associated with the P2P traffic in each of the near future unavailability slots.

13. The system of claim 9, wherein the processing unit being operative to schedule the TxOPs of the non-P2P traffic to the station in the upcoming unavailability periods comprises the processing unit being operative to schedule the TxOPs of the non-P2P traffic to the station during the upcoming unavailability periods in response to determining that the station does not need to respond.

14. The system of claim 9, wherein the processing unit being operative to schedule the TxOPs of the non-P2P traffic to the station in the upcoming unavailability periods comprises the processing unit being operative to schedule the TxOPs of the non-P2P traffic to the station during the upcoming unavailability periods in response to determining that:
the priority associated with the upcoming unavailability periods of the station is not greater than that of the non-P2P traffic;
the non-P2P traffic has already started; and
the station does not need to respond.

15. The system of claim 9, wherein the processing unit being operative to schedule the TxOPs of the non-P2P traffic to the station in the unavailability periods comprises the processing unit being operative to schedule the TxOPs of the non-P2P traffic to the station during the upcoming unavailability periods in response to determining that:
the priority associated with the upcoming unavailability periods of the station is not greater than that of the non-P2P traffic;
the non-P2P traffic has already started; and
the station is able to respond.

16. The system of claim 9, wherein the processing unit being operative to parse the irregular unavailability report comprises the processing unit being operative to determine an interruptible indication of an upcoming unavailability period, wherein the interruptible indication indicates that the station is available for interruption by an Access Point (AP) when the AP has a higher priority traffic for the station than P2P traffic for which the station is absent.

17. A non-transitory computer-readable medium that stores a set of instructions which when executed perform a method executed by the set of instructions comprising:
receiving, by an Access Point (AP), an irregular unavailability report from a station, the irregular unavailability report comprising a priority associated with upcoming unavailability periods of the station for non-Peer-to-Peer (P2P) traffic and an indication of interruptibility of P2P traffic in the upcoming unavailability periods; and
scheduling, by the AP, Transmit Opportunities (TxOPs) of the non-P2P traffic to the station in the upcoming unavailability periods based on the priority associated with upcoming unavailability periods and the indication of the interruptibility of the P2P traffic.

18. The non-transitory computer-readable medium of claim 17, wherein scheduling the TxOPs of the non-P2P traffic to the station in the upcoming unavailability periods comprises scheduling the TxOPs of the non-P2P traffic to the station during the upcoming unavailability periods in response to determining that:
the priority associated with the upcoming unavailability periods of the station is not greater than that of the non-P2P traffic;
the non-P2P traffic has already started; and
the station does not need to respond.

19. The non-transitory computer-readable medium of claim 17, wherein parsing the irregular unavailability report comprises determining an interruptible indication of an upcoming unavailability period, wherein the interruptible indication indicates that the station is available for interruption by the AP when the AP has a higher priority traffic for the station than P2P traffic for which the station is absent.

20. The non-transitory computer-readable medium of claim 17, wherein scheduling the TxOPs of the non-P2P traffic to the station in the upcoming unavailability periods comprises scheduling the TxOPs of the non-P2P traffic to the station during the upcoming unavailability periods in response to determining that the station does not need to respond.
